(19) United States
(12) Patent Application Publication
(10) Pub. No.: US 2019/0389019 A1
(43) Pub. Date: Dec. 26, 2019

(54) TRANSPORT SYSTEM AND METHOD FOR OPERATING A TRANSPORT SYSTEM

(71) Applicant: STICHT TECHNOLOGIE GMBH, Hagenberg (AT)

(72) Inventors: Walter STICHT, Attnang-Puchheim (AT); Christian MERSNIK, Attnang-Puchheim (AT); Christoph NEUDORFER, Vöcklamarkt (AT); Alexander ECKMAYR, Desselbrunn (AT)

(73) Assignee: STICHT TECHNOLOGIE GMBH, Hagenberg (AT)

(21) Appl. No.: 16/483,789

(22) PCT Filed: Feb. 12, 2018
(86) PCT No.: PCT/AT2018/060037

§ 371 Date: Aug. 6, 2019

(30) Foreign Application Priority Data
Feb. 15, 2017 (AT) A 50128/2017

(51) Int. Cl. B23Q 7/14; B23Q 17/22; B23Q 17/24; B65G 17/32

(52) U.S. Cl. CPC B23Q 7/1436; B23Q 17/2208; B60L 53/12; B65G 17/32; B23Q 17/2428

(57) ABSTRACT

The invention relates to a transport system for workpiece carriers along a path, wherein each of a plurality of workpiece carriers has its own drive and energy storage, wherein the drive is effected via a drive means rolling on the guide of the path, said drive means being driven by a motor of the workpiece carrier, wherein at least one absolute value track is attached along the path for position coding of the path and each of a plurality of workpiece carriers has an absolute value sensor, which reads out the absolute value of the absolute value track.

### CROSS-REFERENCE TO RELATED APPLICATIONS

The present application is a national phase application of PCT Application No. PCT/AT2018/060037, filed Feb. 12, 2018, entitled “TRANSPORT SYSTEM AND METHOD FOR OPERATING A TRANSPORT SYSTEM”, which claims the benefit of Austrian Patent Application No. A 50128/2017, filed Feb. 15, 2017, each of which is incorporated by reference in its entirety.

### BACKGROUND OF THE INVENTION

### 1. Field of the Invention

The invention relates to a loosely-linked transport system for workpiece carriers, wherein the workpiece carriers themselves have drive means.

### 2. Description of the Related Art

A workpiece carrier is a device that receives a workpiece that is to be machined. The workpiece carrier is moved successively to a plurality of workstations, each of which carries out machining or handling steps on the workpiece. The transportation of the workpiece carriers is effected by the transport system, wherein “loosely-linked” means that the distance between individual workpiece carriers is variable, or that the workpiece carriers are not necessarily moved on with a fixed uniform cycle, as is the case with a rigid linkage.

Transport systems are known where the drive means are attached on the track. For example, this can occur by moving an endless chain along a pathway, wherein the workpiece carriers are fastened to fixed positions of said chain and are thus are moved synchronously with the movement of the chain. Furthermore, systems are known in which a plurality of endless conveyor belts or endless toothed belts are used on consecutive path sections, wherein the passive workpiece carriers are transferred from one path section to the next.

The disadvantage of transport systems with drive means on the path is that a loose linkage is hardly or not at all feasible and that the individual path sections are relatively expensive.

In addition, it has already been proposed that the path be designed as the stator of a linear drive and the workpiece carriers as rotors, but this again has the disadvantage that the path is complex and expensive. It is also disadvantageous that the stator and thus the entire path is magnetic, which is especially problematic during machining or abrasion (e.g. process-related when screwing or pressing) of ferromagnetic materials.

It is therefore desirable to design the path itself without any drive means and thus cost-effectively, which can be realised by providing each of the workpiece carriers with its own drive.

The following seven documents (EP2444171A1, U.S. Pat. No. 6,089,512A, DE102006049588A1, DE102009049274A1, WO2013068534A2, US2010186618A1, and DE 4411845 A1) relate to the general prior art.

EP 2444171 A1 discloses a rail-bound transport system for transportation of metal bundles weighing several tonnes. Each transport car has an electric motor, which is provided with energy by means of sliding contacts over the rail system.

U.S. Pat. No. 6,089,512 A discloses a track-guided transport system, having a primary coil along the path and a secondary coil having a ferrite core on the transport car for energy transfer by means of magnetic coupling. The motors of the transport cars are driven directly by the transferred energy, wherein the motors represent series loads. Data transfer is implemented with a coaxial cable, which runs over the entire path.

DE 102006049588 A1 discloses a track-guided transport system having a primary conductor system along the path and a secondary coil having a ferrite core on the transport car for energy transfer by means of magnetic coupling. The motors of the transport cars are driven directly by the transferred energy, wherein the motors represent series loads. Data transfer is effected via the primary conductor system and/or with a coaxial cable, which runs over the entire path.

DE 102009049274 A1 discloses a transport system with vehicles which have a sensor, with which a stationary marking is detectable. As soon as a marking is detected, the vehicle is stopped at a stationary transmission and receiving unit following the marking. A transmission and receiving unit is also arranged on the vehicle, which may be coupled to a stationary transmission and receiving unit and used for data exchange.

WO 2013068534 A2 discloses an inductive electrical energy supply of a traffic vehicle, through the use of successive electromagnetic segments.

US 2010186618 A1 discloses a transport system having transport cars, each of which is designed as rotors of a linear motor.

DE 4411845 A1 discloses a method and a device for an improved block control for controlling a train along a rail system. A block control is shown, which is intended for the train operation of a railway system in which energy is supplied in a specific path section in which it is required.

EP0264532 (A1), EP3031334 (A1) and EP0988925 (A1) disclose rail-bound transport systems for workpiece carriers, with the workpiece carrier having a drive and an energy storage. The path is preferably designed in a simple manner. The only task of the path is to form a guide for the workpiece carriers, like the rails of a train. The path can be assembled by the alignment of standard elements, for example straight pieces and curves, similar to a railway line or a model train set. The exact positioning of the workpiece carrier is effected in the workstations; the workstations can also have positional markings, which are detected by the workpiece carrier. The disadvantage here is that the positional markings on the path or along the path must be arranged according to the workstations, which means an additional assembly effort. The charging of the energy storage in the form of an accumulator and/or a capacitor is effected according to these documents in or immediately before the workstations, so that stoppage of the workpiece carriers on the path is problematic. It is also problematic that charging demands a certain amount of time, such that either the dwell time in the workstations must not fall short of a certain minimum time, or a queue of workpiece carriers must be formed before each workstation, causing the number of workpiece carriers to be greater than necessary.

DE19842738 (A1) discloses a rail-bound transport system for workpiece carriers, in which the workpiece carrier has a drive and an energy storage, wherein the charging of the energy storage is contact-free by means of coils, which can be attached along the entire path. The workpiece carriers are preferably supplied with energy in a contact-free manner at all times and at any point on the path, so that the transport system is fail-safe. However, this transport system also has the disadvantage that precise alignment of the workpiece carriers only is effected in the workstation, wherein the workpiece carrier is held in the machining stations and is positioned by means of a positioning unit in respect of the machining tools assigned to the machining stations. In turn, markings in the form of index marks can be applied on the path, for example immediately before the workstations, in order to inform the workpiece carrier that it has reached a workstation. Firstly, it is disadvantageous that the index marks must be applied according to the workstations, and secondly that the precise position of the workpiece carriers on the path is not detectable at all times, at least not immediately after system start-up. This is because the workpiece carrier or the transport system can only detect the position of a workpiece carrier when driving over an unambiguous index mark or when reaching a workstation. After the first exact position detection of the workpiece carrier on the path, its position can be calculated continuously via the rotary encoder of its servomotor, however the workpiece carrier must first cover a certain stretch of path after starting at an unknown starting position. In addition, position detection via the rotary encoder is not overly reliable, as for example wear of the drive roller corrupts the calculation result. In addition, particularly with high accelerations or rapid decelerations, the drive roller of the workpiece carrier may skid or slide (slip) in an uncontrolled manner on the guide, which impairs the exact calculation of the absolute position of the workpiece carrier.

The object of the invention is to provide a fail-safe, rail-bound loosely-linked transport system for self-driving workpiece carriers, which allows a rapid and exact position determination of each workpiece carrier on the path.

A further object is to provide a rail-bound, loosely-linked transport system for self-driving workpiece carriers with high flexibility, with respect to the maximum weight of the transported workpieces, with respect to operational safety and work safety at manual workplaces, with respect to the transport speed and acceleration and with respect to the path design.

### SUMMARY OF THE INVENTION

To achieve the object, a rail-bound transport system having a path for workpiece carriers is proposed, with which the workpiece carriers have a drive and energy storage, wherein the drive is implemented via a drive means rolling on a guide of the path, wherein according to the invention an absolute value track is attached along the path or along each path element of the path, such that by means of absolute value sensors on the workpiece carriers, the absolute positions of said workpiece carriers are detectable at any time.

Thus, each workpiece carrier and path or path element together forms an absolute value transmitter, whereby each workpiece carrier can determine its exact position along the path at any time and can transmit said position to the control system of the transport system. Preferably, this can also occur immediately after system start-up when the workpiece carriers are at a standstill. It is also advantageous that no markings or transducers have to be attached in the workstations so as to stop the workpiece carriers at exact positions. Workstations can thus be positioned at any positions along the path, wherein the control system or the workpiece carrier must only be informed of the unambiguous value of the absolute value track at which the workpiece carrier must stop. The building, realignment, expansion and modification of production lines is thus particularly easily realisable, as only the saved stop positions along the path must be entered, modified or supplemented.

The energy transfer to the workpiece carriers preferably is effected along the entire path, so that upon system start-up each workpiece carrier on the path is immediately provided with energy. The energy transfer preferably is effected in a contact-free manner, for example by means of inductive coupling. For example, the Qi standard can be used. Communication between workpiece carrier and control system can occur via the device for energy transfer, for example as is the case with the Qi standard.

Each workpiece carrier has a motor and a drive means, which rolls on the guide of the path. The motor is preferably designed as a servomotor or step motor. Upon braking, electrical energy is preferably fed back from the motor brake into the energy storage. The motor brake or an additional brake for the drive roller preferably locks in the case of a power failure, or when no energy supply is effected through the transfer modules, or no communication with the control system is possible, in order to prevent any unwanted or uncontrolled movement of the workpiece carriers.

The workpiece carrier also has at least one receiver module, for example in the form of a coil, as a receiver of the transferred energy and at least one sensor for reading the values of the absolute value track. In addition, the workpiece carrier has at least one energy storage, preferably in the form of at least one capacitor, as this can be particularly quickly charged and the saved energy quantity can be emitted particularly quickly. The workpiece carrier can have further sensors, for example distance or proximity sensors, on its front and when applicable rear side in the transport direction, in order to avoid collisions with other workpiece carriers or foreign bodies. The drive means is preferably at least one roller or at least one wheel, in particular a friction roller or a friction wheel, which works on a level surface of the path. More complex longitudinal gearing along the path is thereby not required, as would be the case with gear drives.

The path is preferably composed of standardised path elements. Each path element has along its length a guide for the workpiece carriers, an absolute value track and a device for energy transfer, for example one or a plurality of coils. The individual path elements each preferably have a separate energy supply, so that these can be switched on and off individually by the control system, or can be selectively supplied with power. The absolute value tracks can be designed identically for each path element, which has the advantage that the width or the number of code positions or tracks of the absolute value track can be lower than if a unique coding were provided over the entire length of the path. Furthermore, the sequence of code values of all absolute value tracks can be identical, whereby only one type of absolute value track, for example a track coded with standard Gray code, is necessary, and thus must be manufactured or purchased in large quantities.

In order to ascertain during start-up which workpiece carrier is located on which path element, the control system can power up energy or switch on one path element after the other. If a workpiece carrier is located on the just activated path element, this is powered up, then detects the value of the absolute value track on the path element and sends this code information to the control system. The control system can thus allocate a workpiece carrier to the absolute position on the specific path element. Each workpiece carrier preferably has a unique identifier, for example the serial number of its motor or servo controller, which sends this together with the absolute position or instantaneous value of the absolute value track to the control system. The workpiece carriers and their positions are thereby clearly identifiable by the control system, so that the latter can transmit individual control instructions to each workpiece carrier.

During operation, the control system, given knowledge of the order of the path element, can determine the path element on which a workpiece carrier is located, as said workpiece carrier when leaving one path element inevitably continues on to the next path element.

If the data transfer between the workpiece carrier control system is effected via the path elements, i.e. for example via the coils for energy transfer, the control system can also immediately allocate the workpiece carrier to the respective path element, when the control system has a separate data connection for each path element, or each path element adds to the signals or the data of the workpiece carrier a unique identifier for example in the form of a modulation or code.

The path elements are preferably selected from the following elements: Straight lines, curves, switches, turntables, rotary crossings (straight or curved), terminal loops, slopes or gradients, spirals.

The workpiece carrier is preferably moved laterally along the path elements and not on or over the same, as is for example the case with trains. The drive, its control circuit board, the device for energy transfer and the position sensor and suspension of the workpiece carrier are thus preferably located on one side, laterally next to the path element. Path elements can thereby be positioned back-to-back, in order to be able to realise two-track path sections. In this case, the curve elements are inside curves with a smaller radius and outside curves with a larger radius, which back-to-back form a two-track curve. From the workpiece carrier, facing away from the path, a connecting element or receiving element protrudes laterally, which is used for receiving the workpiece. The workpiece is thus preferably also moved laterally to the path, so that this is accessible from above and below for machining or handling.

With two-track path sections, a track can be preferably used for outgoing transport of the workpiece carrier and the second track for return transport of the workpiece carrier, wherein at the end of the two-track path section a terminal loop is located, which guides the workpiece carrier along an outside curve from the first track into the second track. In this case, the workpiece may not protrude past the respective rear side of the path section.

### BRIEF DESCRIPTION OF THE DRAWINGS

The invention is illustrated on the basis of drawings:

FIG. 1: shows schematically a transport system according to the invention in a production or assembly line.

FIG. 2: shows schematically the absolute value tracks of two path elements according to the invention.

FIG. 3: shows schematically the absolute value tracks and transfer modules of path elements according to the invention.

FIG. 4: shows schematically the absolute value track and transfer modules of an advantageous path element according to the invention.

FIG. 5: shows in section the profile of a one-track path element according to the invention, on which a workpiece carrier according to the invention is fastened.

FIG. 6: shows in section the profile of a two-track path element according to the invention, on which two workpiece carriers according to the invention are fastened.

FIG. 7: shows in perspective the guide profile according to the invention.

FIG. 8: shows a serial interconnection of workpiece carriers.

FIG. 9: shows a series connection of workpiece carriers on a curve of the path.

FIG. 10: shows a serial and parallel interconnection of four workpiece carriers.

FIG. 11: shows a series and parallel connection of four workpiece carriers on a curve of the path.

FIG. 12: shows an interconnection of a workpiece carrier having a servomotor and a workpiece carrier having a step motor with a visualisation of the inactivation of the servo drive.

FIG. 13: shows a one-track straight path element according to the invention.

FIG. 14: shows a two-track straight path element according to the invention.

FIG. 15: shows an inside curve element according to the invention.

FIG. 16: shows an outside curve element according to the invention.

FIG. 17: shows a terminal loop element according to the invention.

FIG. 18: shows rotary elements according to the invention.

FIG. 19: shows transport elements according to the invention for displacement of path elements.

FIG. 20: shows a lifting element according to the invention.

FIG. 21: shows pivot elements according to the invention.

FIG. 22: shows an exemplary path according to the invention with the connection of a laser welding cell.

FIG. 23: shows an exemplary path according to the invention with path elements according to the invention for changing the conveying plane.

FIG. 24: shows a scissor lift table constructed with workpiece carriers according to the invention.

FIG. 25: shows a movement platform constructed with workpiece carriers according to the invention.

FIG. 26: shows schematically a manual workplace with a transport system according to the invention.

FIG. 27: shows schematically a transport system according to the invention for manual workplaces in a sectional view.

FIG. 28: shows schematically a transport system according to the invention for manual workplaces in a view perpendicular to the conveying plane.

### DETAILED DESCRIPTION

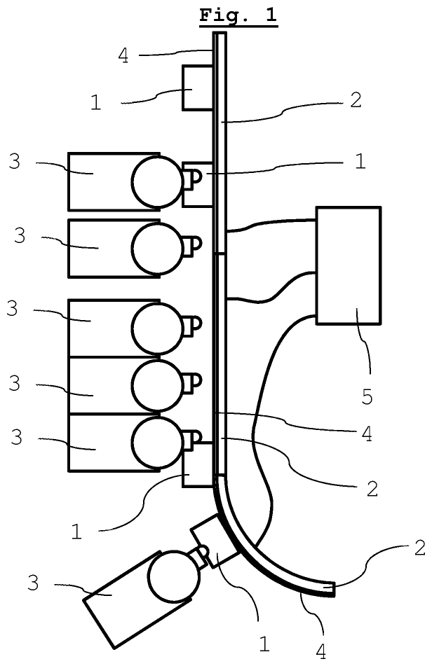

FIG. 1 schematically illustrates a transport system according to the invention in a production line. The transport system has self-driving workpiece carriers 1, which can drive at any distance to one another and with varying speeds along the path, wherein the path is composed of a plurality of path elements 2, as shown for example from two straights and an outside curve. Along the path, there are workstations 3, which can be designed as machining stations or manual handling stations and which execute work steps on the workpiece. Each path element 2 has in its longitudinal direction, i.e. along the transport direction of the production line, an absolute value track 4, which has at each locational position along the path element 2 an unambiguous value or code value (also referred to as a unique code value), particularly a digital value, for example a dual code or Gray code. On each workpiece carrier 1, there is a sensor for detecting the code value, whereby the absolute position of each workpiece carrier 1 on the respective path element 2 is continuously detectable. The workpiece carriers 1 communicate their absolute position to a control system 5. The control system 5 sends control commands to the workpiece carrier 1, in particular the absolute value or absolute values within a path element 2 at which the workpiece carrier 1 must stop for machining by the workstations 3. As the workpiece carrier 1 can be stopped exactly at any position path element 2, the workstations 3 can be located at positions along the path elements 2. When constructing the production line, only absolute values, which the sensor of the workpiece carrier 1 detects in the respective machining position, must be saved to the workstations 3. The absolute value track 4 is preferably designed as an absolute value band that is flexible in the longitudinal direction or an absolute value strip that is flexible in the longitudinal direction, which is fastened, i.e. bonded, to the respective path element 2. In particular for straight path elements 2, a rigid absolute value line can also be used.

The absolute value band can preferably be attached without problem to curve elements, so that the absolute positions of the workpiece carriers 1 can also be detected at any time on the curves of the production line, so that workstations 3 can also be arranged in the area of the curves.

As movements with the workpiece carriers 1 can be very exactly performed and controlled or documented by the absolute value track 4 on one hand and the servo controller or step motor control of the workpiece carrier 1 on the other hand, the workpiece carrier 1 can also be moved during the machining by a workstation 3, for example the tool or gripper of the workstation 3 and the workpiece carrier 1 can be synchronously moved, so that a stopping of the workpiece carrier 1 in the working range of the workstation 3 can be completely omitted. As the direction of movement of the workpiece carrier 1 is reversible, these could also be moved cyclically back and forth between two or more workstations 3.

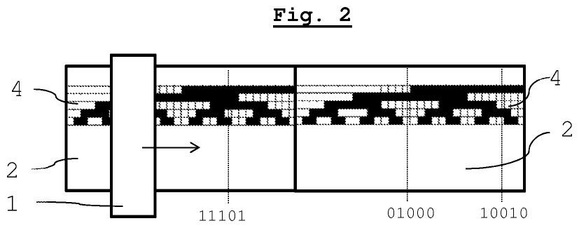

FIG. 2 schematically shows as an example the two straight path elements 2 of FIG. 1 as viewed towards the workstations 3. Each path element 2 has an absolute value track 4, which is shown in FIG. 4 as 5-bit standard Gray code. The absolute value tracks 4 of all path elements 2 can be designed identically. Within each path element 2, each discrete position along the absolute value track 4 has a unique, i.e. clear code value, so that the absolute positions of all workpiece carriers 1 are known at all times. The workpiece carrier 1, the direction of movement of which is highlighted with an arrow, receives, e.g. is informed by the control system 5 that it should stop in the current path element 2 at the position 11101 and in the following path element 2 at the positions 01000 and 10010.

As due to the known code sequence from the momentarily measured absolute value of the workpiece carrier 1 at each time the distance to the next stop point is calculable, the braking process of the workpiece carrier 1 can be started at the correct, or latest possible time. Should the workpiece carrier 1 for example travel beyond the stop point due to blockage of its drive wheel (i.e. in the event of uncontrolled sliding of the workpiece carrier 1), then this can be moved back to the stop point by reversing the direction of its servo or step motor.

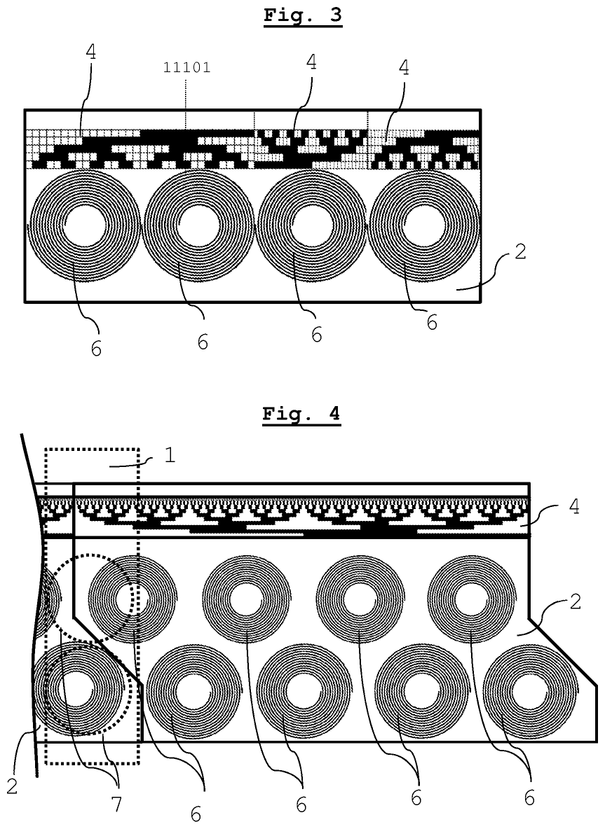

It is advantageous if the length of the path elements 2 is selected such that each position on the path element 2 has an individual code value. It is however naturally also possible to fix to a path element 2 a plurality of successive identical or different absolute value tracks 4, as is shown in FIG. 3. In this case, the clear position detection of the workpiece carrier 1 after a power failure can occur by activating or deactivating the energy supply on the path element 2 divided according to the absolute value tracks 4, or in finer intermediate steps. The clear position detection of the workpiece carrier 1 can however also occur in that the communication of the workpiece carrier 1 is effected with communication modules on the path according to the absolute value tracks 4, or in finer intermediate steps. Wherein it can be detected by the control system 5, the communication module with which the workpiece carrier 1 is currently communicating. The communication of the control system 5 with the workpiece carriers 1 and/or the path elements 2 or their transfer modules 6 is effected preferably with a fieldbus system, preferably a CAN bus, in order to keep the cabling low.

The energy supply and/or data transfer is effected via transfer modules 6, for example in the form of coils. The transfer modules 6 can be used for energy and data transfer, by modulating the transferred energy so that this transports a piece of information. The data transfer can also occur independently of the energy supply according to the principle of near field communication or RFID technology. Communication between the workpiece carriers 1 and the control system 5 can also occur completely independently of the path elements 2, for example via radio. If the transfer modules 6 only transfer energy, then upon start-up of the path element 2 of FIG. 3 the control system 5 can supply each transfer module 6 individually with power, for example sequentially. If a workpiece carrier 1 is located for example at position 11101 of the first absolute value track 4, then this workpiece carrier 1 delivers upon activation of the second transfer module 6 a signal to the control system 5, which contains this position information and preferably a clear identification characteristic of the workpiece carrier 1. As the third and fourth transfer module 6 of the path element 2 are not yet transferring energy at this point, it is possible to rule out that the workpiece carrier 1 is located at position 11101 of the second or third absolute value track 4. As can be seen in FIG. 3, absolute value tracks 4 with different spatial resolution can be used, i.e. with a different expansion of the code positions in the transport direction, for example, in order to be able to more accurately position in the region of workstations 3 and to provide in areas, which are used purely to return empty workpiece carriers 1 to the start of the production path, more cost-effective path elements 2 with more approximate spatial resolution.

Successive path elements 2 can have identical code values at their absolute value tracks 4, which however does not mean that the absolute value tracks 4 must be identical. In this way, path elements 2 can be provided for example with identical code sequences, wherein however the starting value of the respective absolute value track 4 at the start of the path element 2 is different.

If for example a two metre long code band is used to produce the absolute value tracks 4 as a starting point and the path element length is for example 360 mm, then the absolute value track 4 for the path element 2 can be cut at a position of the two metre long code band.

In addition, the order of the code values of the absolute value tracks 4 can be different from path elements 2, for example a path element 2 can have a standard Gray code (reflected binary Gray code) and another path element 2 can have a dual code, or another Gray code, such that the path elements 2 or the type of path elements 2 can be differentiated on the basis of their code sequence.

Different types of path elements 2 preferably have absolute value tracks 4 with different code sequences, wherein the code sequences are known to the control system 5. With different types of path elements 2, the length of the absolute value tracks 4 can also be different, as is the case at least with inside and outside curve elements. After building the path, it is thereby possible by departing with one workpiece carrier 1 to read the path layout, as the arrangement of path elements 2 results from the sequence of different code sequences. Upon the first-time departure, the workpiece carrier 1 sends the detected absolute values successively to the control system 5, which saves this code sequence. Should path elements 2 with absolute value tracks 4 with identical code sequences exist, their position can be determined by the following two variations.

If the control system 5 can detect on the basis of the signals of the transfer modules 6 the path element 2 over which the workpiece carrier 1 is currently moving, the position of each individual path element 2 in the path layout can be derived from the order, in which the signal switches between the path elements 2. If the control system 5 can only operate the power supply of the path elements 2 individually, then the path layout can be read in that one after the other is always supplied with power from the remaining one at the end of a path element 2 until the workpiece carrier 1 moves on again. Of course, before, during or after the construction of the path, the arrangement of the path elements 2 can also be saved in the form of a plant plan, or by programming in the control system 5, without following the path, wherein with the known code sequence each absolute value track of the used path elements 2 the code sequence of the entire path is also already known.

In FIG. 4, an advantageous embodiment of a path element 2 is shown, which has an absolute value track 4 and two rows of transfer modules 6 in the form of coils for energy transfer and preferably also for data transfer. On the left edge of the screen, the end of the preceding path element 2 is shown. The two rows of transfer modules 6 are arranged offset to one another. The workpiece carrier 1 highlighted with dashed lines in FIG. 4 has two receiving modules 7, which are arranged directly beneath each other according to the two rows of the transfer modules 6 of the path elements 2, such that at least one of the receiving modules 7 is always in the transfer area of one of the transfer modules 6.

The outermost transfer module 6 of a row is preferably located in the joint area of the guides of the successive path elements 2. It is thereby guaranteed that even workpiece carriers 1, which come to a standstill precisely in the joint area of two path elements 2, are provided with energy and preferably with information at the same time when activating the transfer modules 6. If in the joint area between the two path elements 2 or in the joint area between two absolute value tracks 4 a gap exists, the position of which is thus not coded with an absolute value, it may occur that a workpiece carrier 1 comes to a standstill precisely in this position in the case of power failure. In the event of re-start-up, the position of the workpiece carrier 1 can still be detected, if it is detectable from the signal of the absolute value sensor 20 of the workpiece carrier 1 that this is directed at the gap (for example, an error signal could be emitted). However, if the gap is read as 111111 or 000000, then this value should not be contained in the code values of the absolute value tracks 4. As the workpiece carrier 1 at the position of the gap is still provided with energy and possibly also with information by at least one of the adjacent path elements 2, its position can be detected upon successive activation of the transfer modules 6, without any movement of the workpiece carrier 1. Each workpiece carrier 1 can also be equipped with two or more absolute value sensors 20, spaced at a distance to one another in the transport direction. With absolute value tracks 4 each with individual code sequences, the absolute position within the entire path could be thus obtained by the succession of the code values detected by the two or more absolute value sensors 20 spaced at a distance to one another in the transport direction. In addition, parallel to the respective absolute value track 4, which provides the coding of the locational position within the path element 2, a second code track with constant value can be attached, wherein the constant value is different from path element 2 to path element 2.

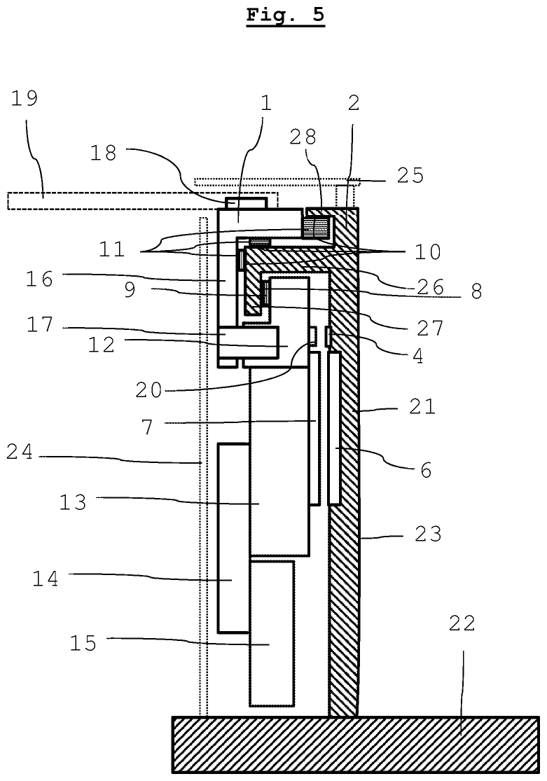

In FIG. 5, a cross-section through an advantageous path element 2 is shown, with a workpiece carrier 1 attached thereon. The path element 2 has a running surface 8, on which the drive roller 9 or the rotating drive means of the workpiece carrier 1 abuts.

The path element 2 also has guide surfaces 10, on which guide rollers 11 or guide wheels of the workpiece carrier 1 abut. The workpiece carrier 1 is thus mounted on the path element 2 by the drive roller 9 and by the guide rollers 11. The running surfaces 8 and a guide surface 10 are preferably aligned parallel to one another, wherein the drive roller 9 and at least one guide roller 11 abut from opposing sides on the running surface 8 and guide surface 10. A second and a third guide surface 10 are also preferably present, which are positioned in parallel to each other and are aligned at an angle of 90° to the running surface 8 and to the first guide surface 10. The workpiece carrier 1 preferably has at least a second and third guide roller 11, which abut from opposing sides on the second and third guide surface 10.

The workpiece carrier 1 has a drive element 12, in which the drive roller 9 is mounted. On the drive element 12, there is a motor 13, a control circuit board 14 and an energy storage 15. Between the drive roller 9 and motor 13, a gear can be located, the drive roller being preferably connected directly with the motor shaft or attached to the same. The workpiece carrier 1 also has a guide element 16, which is preferably detachably connected via a connecting element 17 with the drive element 12.

By disengaging the connection between the drive element 12 and guide element 16, the workpiece carrier 1 can be taken from the path element 2, for example to be able to remove defective workpiece carriers 1 at an position on the path. Complete workpiece carriers 1 can be slid at open ends of the path into the same or removed from the path at open ends.

In the guide element 16, the guide rollers 11 are mounted, wherein these are passively designed, i.e. without a drive. The workpiece carrier 1 has a connecting element 18, which serves to fasten a mounting plate 19 or a similar fastening device for the workpiece on the workpiece carrier 1. Furthermore, the workpiece carrier 1 has an absolute value sensor 20, with which the code value of the absolute value track 4 of the path element 2 is read and at least one receiving module 7, which receives the energy from at least one transfer module 6 of the path element 2. The absolute value sensor 20 and the receiving module or modules 7 are preferably provided on the drive element 12 of the workpiece carrier 1. Thus the guide element 16 can be designed without electronic components and electrical wires. It is naturally possible to provide a conductive connection from the receiving module 7 or from the energy storage 15 to the guide element 16 and subsequently to the mounting plate 19, for example to provide actuators of the, or on the, mounting plate 19 with energy and/or information. For example, a rotatory axis can be provided in the mounting plate 19, in order to mount the workpiece rotatably on the workpiece carrier 1. With the rotatory axis, so-called “pushing on” can advantageously be provided in curves of the path, i.e. a rotation of the workpiece with the effect that its spatial alignment is maintained in the curve. In addition, sensors, operating elements, display elements, switches, cameras and other electrical components can also be on the workpiece carrier 1 or on the mounting plate 19 or the transported component itself and be supplied with energy during transportation via the workpiece carrier 1.

The path element 2 has a base element 21, which is mounted on a base plate 22 at an angle of preferably 90°. The base element 21 has on its side facing towards the workpiece carrier 1 the absolute value track 4 and a guide profile, on which the running surface 8 and guide surfaces 10 are provided. Preferably, the guide profile is detachably mounted on the end of the base element 21 away from the base plate 22. In addition, at least one transfer module 6 is fastened to the base element 21. The base element 21 is preferably designed on its rear side 23 such that two path elements 2 can be fastened with their rear sides 23 abutting each other on the base plate 22, as shown in FIG. 6.

If, as shown in FIG. 5, only one path element 2 is mounted, a mounting angle (not shown) can be fastened to the rear side 23 for support against the base plate 22.

Coverings 24 and 25 are preferably attached on the path element 2, wherein a lateral covering 24 is provided parallel to the base element 21, and an upper covering 25 is provided on the end of the path element 2 removed from the base plate 22. The workpiece carrier 1 is located in the space, which is formed between the lateral covering 24 and the base element 21, wherein this space is limited downwards by the base plate 22 and upwards by the upper covering 25. As is shown in FIG. 5, only the mounting plate 19, or a mounting element for the same, protrudes from a lateral gap between the lateral covering 24 and upper covering 25. The workpiece carrier 1 and its guides are thereby very well protected from contamination and the penetration of foreign bodies. The transport system according to the invention can be designed as a so-called encapsulated system.

As shown, the guide profile has a base leg 26 protruding from the base element 21 at an angle of 90°, on the side of said base leg facing away from the base plate 22 a first guide surface 10 for a first guide roller 11 of the guide element 16 is positioned. On the end of the base leg 26 facing away from the base element 21, a further leg 27 connects at an angle of 90° in the direction of the base plate 22. The running surface 8 for the drive roller 9 is positioned on the side of the further leg 27 facing away from the base element 21. On the side of the further leg 27 facing away from the base element 21, there is a second guide surface 10 for a second guide roller 11 of the guide element 16.

In the direction of the end of the base element 21 facing away from the base plate 22, an additional leg 28, spaced from the base leg 26 and parallel to the same, is located, on the side of said additional leg facing towards the base leg 26 a third guide surface 10 for a third guide roller 11 of the guide element 16 is located.

The drive roller 9, the absolute value sensor 20, the absolute value track 4 and the receiving modules 7 are located in the space, which is defined between the base leg 26, the base element 21, the base plate 22 and an intended extension of the further leg 27 in the direction of the base plate 22. The absolute value track 4 in particular is thereby protected from contamination. The base plate 22 can be aligned in any spatial direction, i.e. as shown horizontally with upwardly protruding base element 21, or horizontally with downwardly protruding base element 21, or vertically or at any angle therebetween. The absolute value sensor 20 of the workpiece carrier 1 is preferably designed as an optical sensor, which detects for example light/dark differences of the absolute value track 4. For this purpose, the absolute value sensor 20 preferably has a light source, the light of which is reflected by the absolute value track 4 back to the absolute value sensor 20. The absolute value sensor 20 has for example ten photo sensors for reading a ten-digit absolute value track 4, which thus contains ten parallel tracks or lines. The number of tracks or lines of the absolute value track 4 complies with the necessary spatial resolution and the length of an absolute value track 4.

A linear scale with at least one Vernier track can preferably be used as the absolute value track, wherein the calculation of the absolute position can preferably occur on the basis of a 2-track or 3-track Vernier calculation.

An absolute value track 4 having a quantity of three tracks can be preferably used, said tracks existing as one incremental track and two Vernier tracks. The workpiece carriers 1 have relevant optical or magnetic sensors for reading the Vernier tracks. For example, the Vernier band can exist as a bridging band (with three mutually phase-shifted incremental tracks) made of ferromagnetic steel and be scanned with three magneto-resistive sensors.

The absolute value track 4 of the individual path elements 2 is preferably cut from a (Vernier) absolute value band with 2,350 mm length and a resolution of 22 bit, which means a spatial resolution of approx. 0.56 μm. If the entire (Vernier) absolute value band is used as an individual absolute value track 4, this could thus have a length of max. 2,350 mm along the path. However, the absolute value track 4 is preferably cut according to the grid spacing or according to the length of the path elements 2.

An absolute value track 4 preferably has a quantity of approx. 2\hat{ }20 clear positional values with a length of 360 mm (preferred grid spacing R).

The spatial resolution of the absolute value track 4 is preferably between 0.2 and 1 μm, particularly preferably between 0.3 and 0.6 μm. For path elements 2 without workstations 3, the spatial resolution can however also be selected to be considerably more approximate.

The achievable positioning accuracy of the workpiece carrier 1 is above the spatial resolution of the absolute value track 4 due to a reserve for the regulation, securities and tolerances and can be provided with approx. 10 μm. The positioning accuracy is preferably between 1 μm and 50 μm, particularly preferably between 5 μm and 20 μm.

Due to the rotary encoder of the servomotor or the stepwise control of the step motor, the computational extent of a movement can be calculated on the basis of the rotary movement of the motor 13 when the diameter of the drive roller 9 is known. As the actual extent of each movement of the workpiece carrier 1 is also detectable on the basis of the absolute value track 4, the computational extent and the actual extent of a movement can be compared. This is preferably used for wear detection of the drive roller 9, as wear causes a gradual deterioration of the concordance. The slipping or blocking of the drive roller 9 can be detected on the basis of non-repeating deviations of the computational movement and the actual extent of the movement. In this way, positive and negative peak acceleration can be preferably calculated for each workpiece carrier 1 depending on the transported weight.

A servomotor with a high torque without gears is preferably used, with the advantage that there can be no gear faults or gear backlash. Furthermore, the servomotor has an absolute or incremental encoder and optionally an incorporated brake.

A step motor with an accurately defined torque curve, without gears, without encoder and optionally with an incorporated brake is preferably used.

At least a capacitor or super-capacitor (SuperCap) is preferably used as the energy storage 15, said capacitor or super-capacitor having a size which absorbs the necessary peaks through for example the accelerating and braking phases of a movement.

The drive roller 9 preferably has a diameter of 10 to 20 mm. The diameter of the drive roller 9 is selected in order to set a necessary or admissible maximum speed depending on the used motor.

The workpiece carrier 1 preferably has dimensions of 50×50 mm without the mounting plate 19, when viewed from above (perpendicular to the conveying plane). The workpiece carrier 1 has the lowest possible tar weight, preferably of not more than 1.5 kg.

In FIG. 6, two mirror-opposite path elements 2, each with a workpiece carrier 1, are shown. As the transport of each workpiece carrier 1 can occur in both directions of the path by changing the rotation direction of its motor 13, the two workpiece carriers 1 can either be transported in the same direction of the path or mutually opposite. Two or more workpiece carriers 1, regulated by the absolute value transmitter consisting of absolute value track 4 and absolute value sensor 20, can thereby be moved synchronously along the path. It is thereby possible to move a connection of workpiece carriers 1 through the path, wherein the workpiece carriers 1 can preferably be connected by mutual mounting plates 19. The weight of the workpiece and its mounting platform can thereby be split over a plurality of workpiece carriers 1.

If the workpiece carriers 1 are each designed for example for the transportation of max. 5 kg of operating load, then an operating load of approx. 10-25 kg can be moved by the interconnection of two workpiece carriers 1. With a connection of for example four workpiece carriers 1, higher operating loads can also be transported. The connection of workpiece carriers 1 can occur in series or in parallel in the transport direction.

In FIG. 7, the guide profile of the path elements 2 in cooperation with the drive roller 9 and the guide rollers 11 of a workpiece carrier 1 is shown in detail. As shown in FIG. 7, one horizontal and one vertical pair of guide rollers 11 are preferably provided in each case, which abut the same guide surface 10 of the guide profile spaced apart from each other in the transport direction. The guide roller 11, which abuts the underside of the additional leg 28, is located, when viewed in the transport direction, between the horizontal pair of guide rollers 11, which abuts the upper side of the base leg 26. The drive roller 9, which abuts the rear side of the further leg 27, is located, when viewed in the transport direction, between the vertical pair of guide rollers 11, which abuts the front side of the further leg 27. Three rollers abutting opposing surfaces thereby each form a three-point bearing with regard to the plane of these surfaces. The drive roller 9 is preferably pressed against the running surface 8 by a force, preferably by a spring action, wherein either the drive roller 9, or the opposing guide rollers 11, is provided with a spring, or a pressing element, for this purpose. The horizontal guide rollers 11 can also be pressed against the guide surfaces 10 by a force, preferably by a spring action, by providing at least one of the horizontal guide rollers 11 with a spring or a pressing element. The rollers, each abutting opposing surfaces, have a mobility with and contrary to the force of the spring action or with or contrary to the force of the pressing element, such that the distance between the rollers, each abutting opposing surfaces, is changeable, such that distance changes between the opposing rollers, for example due to a curve of the base leg 26 and/or the further leg 27, can be balanced.

As shown in FIG. 7, the guide profile is provided with platings, which form the guide surfaces 10 and the running surface 8. The platings and the guide and drive rollers are preferably formed from hardened steel. With plastic-coated steel rollers, it is apparent that these, with the high accelerations achievable with the servomotors, do not withstand the loads, resulting in the plastic coating peeling off the steel rollers. Against expectations, it has been ascertained that enough friction is achieved, even with the hardened steel rollers, to prevent a slipping or sliding of the workpiece carrier 1. Should this occur nevertheless, the extent of the resultant positional deviation is immediately visible in the signal of the absolute value sensor 20. In order to achieve a gentle transition between the platings, these can be provided sloping at the abutment edge when viewed in the transport direction, wherein with successive path elements 2 the platings of a path element 2 can protrude somewhat with their inclined abutment edge into the other path element 2. The additional leg 28 can be designed completely as plating as shown.

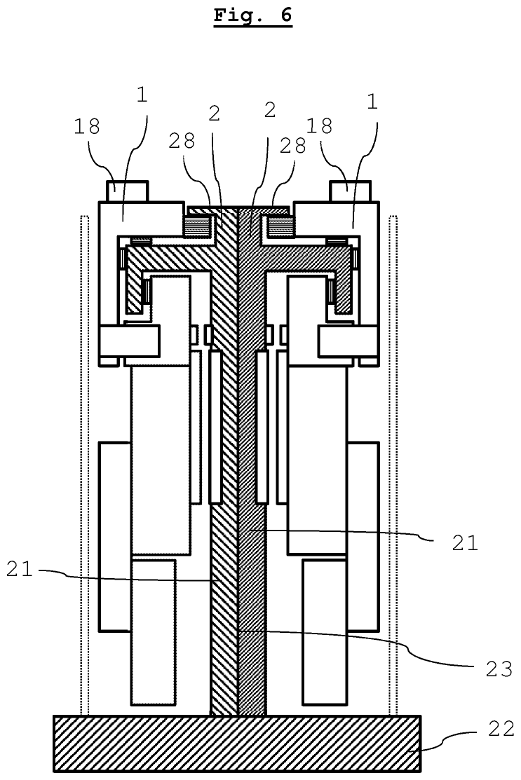

In FIG. 8-11, two exemplary interconnection variations of workpiece carriers 1 are shown. FIGS. 8 and 9 shows the series connection of two workpiece carriers 1 on a single-track path element 2 viewed vertically to the leg 26, 28. A connecting part 29 connects the two workpiece carriers 1, so that these are mechanically connected. The connecting elements 18 are preferably designed as cylinders and rotatably mounted about their axis in the connecting part 29 or in the guide element 16, so that the series connection can also pass curves of the path as shown in FIG. 9. The connecting elements 18 are preferably connected rigidly with the guide element 16 and protrude into recesses of the connecting part 29.

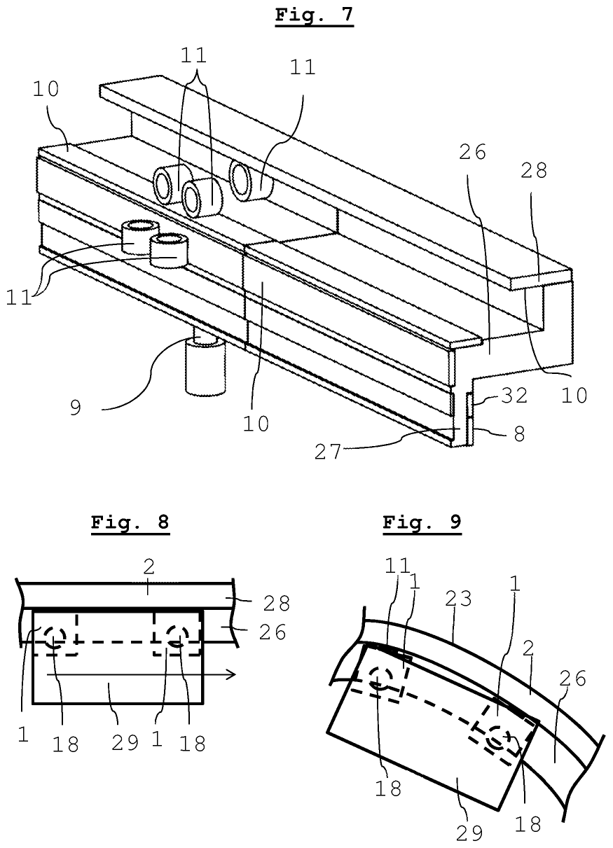

In FIGS. 10 and 11, an interconnection of four workpiece carriers 1 is shown, wherein each two serially connected workpiece carriers 1 are connected in parallel. The parallel connection of the workpiece carrier 1 requires a two-track path made of two path elements 2, which are positioned rear sides 23 together. The connecting part 29 extends over the rear sides 23 and connects the workpiece carriers 1 of the two path elements 2. For this reason, the two-track path constitutes a single-track path for parallel-connected workpiece carriers 1. As shown in FIG. 11, the interconnection of four workpiece carriers 1 can also pass curves, if the connecting elements 18 of the workpiece carriers 1 are connected rotatably about their axes with the connecting part 29.

Should a path only have straight path elements 2, then the connection of the workpiece carriers 1 can be rigid, i.e. without mobility of the connecting part 29 about the connecting element 18, wherein a quantity of workpiece carriers 1 can be connected in series. In order to connect more than two workpiece carriers 1 in parallel, a further path element 2 can be attached in parallel and spaced from the straight, two-track path section.

Should the path have curves in the conveying plane, the connecting part 29 require a mobility in the conveying plane. Should a transition element in the form of a riser or a curve from a first conveying plane to a second conveying plane exist on the path, then the connecting parts 29 must also have a mobility perpendicular to the conveying plane. The plane, on which the guide surface 10 of the base leg 26 is positioned, or a plane that is parallel thereto, can be viewed as the conveying plane.

The connection of the workpiece carriers 1 can occur by means of chain links, wherein the chain links preferably transfer pulling forces and thrust forces between the workpiece carriers 1, such that the forward movement can occur independently of the first link set, or of the workpiece carrier 1 of the first link set.

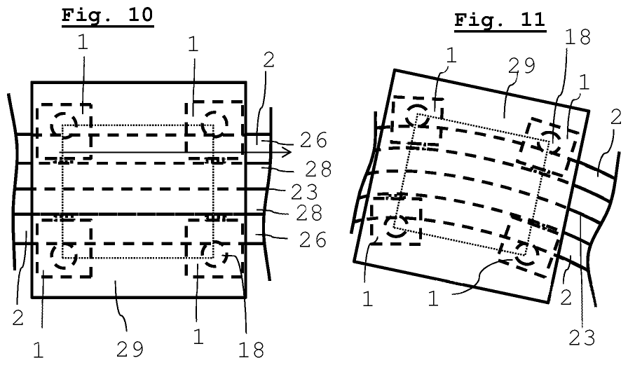

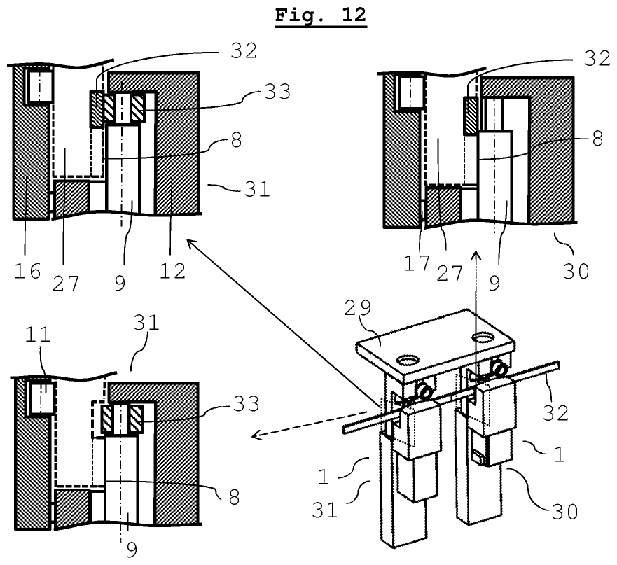

In a particularly advantageous embodiment of a workpiece carrier interconnection, it is provided that at least one workpiece carrier 1 with step motor, i.e. a step motor workpiece carrier 30, and at least one workpiece carrier 1 with servomotor, i.e. a servomotor workpiece carrier 31, are provided in the workpiece carrier interconnection, as highlighted in the perspective view in the bottom right in FIG. 12.

It is advantageous that the workpiece carrier interconnection in areas with automatic machining can be accelerated very rapidly through workstations 3 by the servomotor and can be transported with a high terminal velocity.

Depending on the health and safety regulations, however, the transportation of a workpiece carrier 1 with a servo drive in manual work areas may not be allowed or such an operation in manual work areas is connected with an increased risk of injury.

With the workpiece carrier interconnection with step motor workpiece carrier 30 and servomotor workpiece carrier 31, the servo drive may be inactivated in manual work areas, and the workpiece carrier interconnection may be transported solely by the step motor in the manual work area. The inactivation of the workpiece carrier 1 with servo drive preferably is effected by mechanical decoupling of its drive roller 9 from the running surface 8. For this purpose, on the path elements 2 in the manual work area, a lifting bar 32 is preferably attached to the further leg 27 next to the running surface 8, which lifts the drive roller 9 of servomotor workpiece carriers 31, but not the drive roller 9 of step motor workpiece carriers 30. Relevant lifting bars 32 can be attached both to straight path elements 2 and curve elements. The drive element 12 of servomotor workpiece carriers 31 and step motor workpiece carriers 30 is preferably designed identically aside from a lifting roller 33. The lifting roller 33 is used for servomotor workpiece carriers 31 and not for step motor workpiece carriers 30, wherein the lifting roller 33 is mounted in the drive element 12 in a freely rotatable manner, i.e. without coupling with the drive shaft of the servomotor. The distance of the lifting roller 33 to the lifting bar 32 is somewhat less than the distance of the drive roller 9 to the running surface 8.

If a lifting bar 32 is mounted on the further leg 27, the lifting roller 33 abuts this and presses the drive element 12 slightly from the further leg 27, such that the drive roller 9 has no contact with the running surface 8, as is shown in the top left in FIG. 12. Through this mechanical decoupling, it is guaranteed that even in the case of an unintended or erroneous start-up of the servomotor, no movement of the servomotor workpiece carrier 31 occurs. Simple structural conditions arise if the lifting roller 33 is mounted freely rotatable on the shaft of the drive roller 8 and has a somewhat larger diameter than the drive roller 9.

As shown in the top right in FIG. 12, no lifting roller 33 is used for the step motor workpiece carrier 30, whereby a lifting bar 32 is present, the drive roller 9 is back in contact with the running surface 8. The running surface 8 and the surface of the lifting bar 32 are preferably flush-mounted. Wherein the running surface 8 is preferably provided on a plating, which has the same thickness as the lifting bar 32, as shown in FIG. 7. The drive roller 8 can advantageously jut over the plating of the running surface 8 somewhat in the direction of the lifting bar 32, such that it is ensured that the lifting roller 33 cannot come into contact with the running surface 8, which would result in an unwanted lifting of the drive roller.

In the bottom left in FIG. 12, the servomotor workpiece carrier 31 is shown in path areas without a lifting bar 32. Due to the lack of the lifting bar 32, there is a groove in the further leg 26 between the running surface 8 and the base leg 26, wherein the lifting roller 33 of the servomotor workpiece carrier 31 protrudes somewhat into said groove, but has no contact with the groove surfaces. The drive roller 9 is thereby in contact with the running surface 8 and rolls off same when driven by the servomotor.

In the case that the servomotor workpiece carrier 31 is not interconnected with a step motor workpiece carrier 30, this can also be moved manually through the manual work area, as the lifting roller 33 provides no significant force opposing the movement. Also in this case, the position of the servomotor workpiece carrier 31 is and remains detectable at all times due to the absolute value track 4.

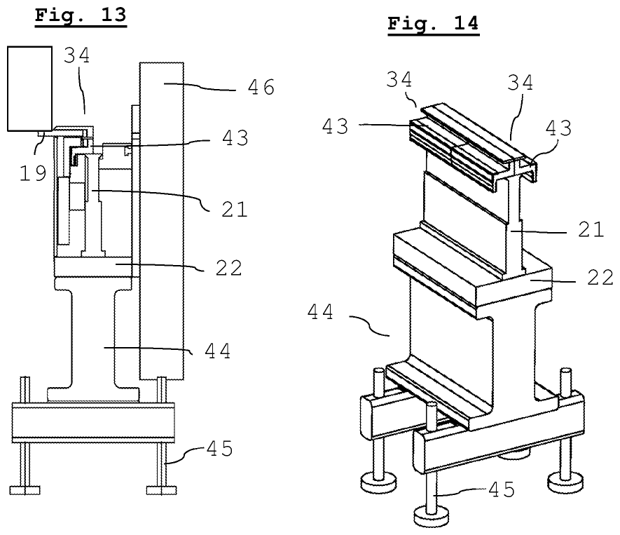

Below, a number of possible path elements 2 are explained on the basis of FIGS. 13 to 24.

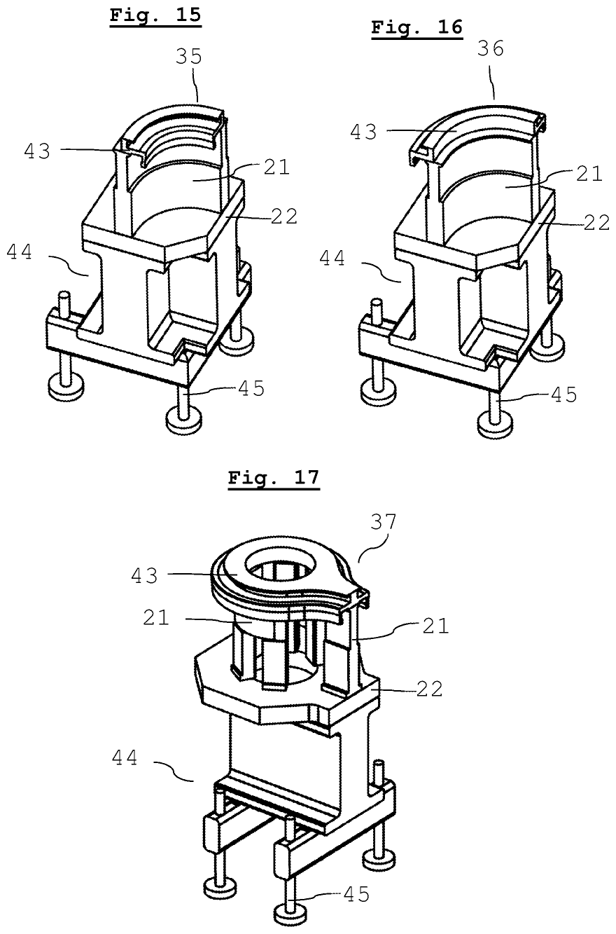

FIGS. 13 and 14 show straight elements 34. FIG. 15 shows an inside curve element 35 and FIG. 16 shows an outside curve element 36. FIG. 17 shows a terminal loop element 37 and FIG. 18 shows rotary elements 38.

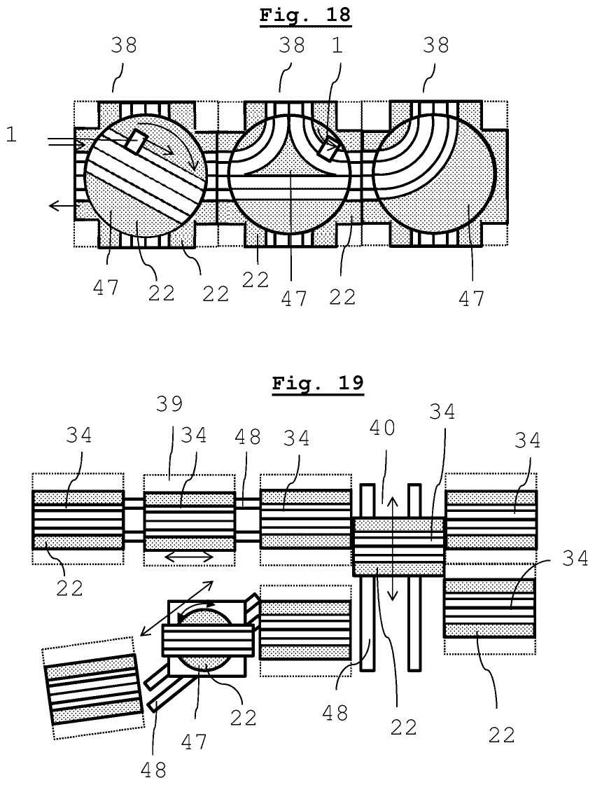

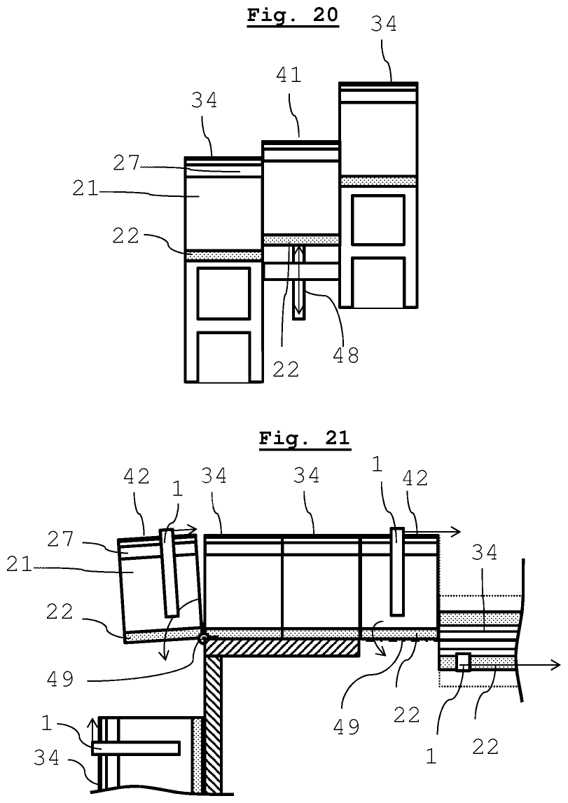

FIG. 19 shows transport elements 39, 40 in the form of a longitudinal transport element 39 and a transverse transport element 40. FIG. 20 shows a lifting element 41. FIG. 21 shows pivot elements 42. FIG. 23 shows helical, curve and riser elements for changing the position or alignment of the conveying plane.

FIG. 13 shows a straight element 34, which, when viewed in the transport direction, comprises a straight base element 21. A straight, separate guide profile 43 is mounted on the base element 21. The base element 21 is mounted on a base plate 22 and is designed in duplicate, such that on its end that is removed from the base plate 22 two separate guide profiles 43 can be mounted with rear sides together.

In FIG. 14, a path element 2 having two straight elements 34 is shown, which are formed by two separate guide profiles 43, which are attached with rear sides together on the base plate 22, for forming a two-track path section. FIGS. 13 and 14 also show a preferred substructure 44 for path elements 2, which consist of two or more stayers, which are supported on height-adjustable feet 45. Through individual height adjustment of the preferably four height-adjustable feet 45, an exact alignment of the path elements 2 in relation to the conveying plane can occur. FIG. 13 also shows a workpiece carrier 1, which conveys a workpiece shown as a rectangle mounted on a mounting plate 19. The workpiece is preferably a component group, which is assembled in the production plant, wherein, manually or in the workstations 3, parts are respectively inserted, manipulated and/or joined, for example glued, screwed or welded. The transport system according to the invention can therefore be preferably used in assembly lines for component groups with a weight of less than 100 kg, preferably less than 50 kg, particularly preferably less than 10 kg. Component groups of less than 5 kg are particularly preferably, such that these are transportable with just one workpiece carrier 1 according to the invention. Furthermore, FIG. 13 shows the connection of a stayer 46 to the single-track path element 2, which is fastened on the base element 21 on one side laterally on the base plate 22 and on the other side on the mounting element, for example with a tongue-and-groove joint. The stayer 46 can for example be used to connect a workstation 3 to the path or to fix the path element 2 and a workstation 3 at a fixed distance from one another.

FIG. 15 shows an inside curve element 35, which, when viewed in the transport direction, comprises a circular-segmented base element 21, wherein a circular-segmented separate guide profile 43 is attached to the side of the base element 21 with the smaller radius.

FIG. 16 shows an outside curve element 36, which, when viewed in the transport direction, comprises a circular-segmented base element 21, wherein a circular-segmented separate guide profile 43 is attached to the side of the base element 21 with the greater radius, wherein the outer radius of the separate guide profile 43 of the inside curve element 35 is equal to the inner radius of the separate guide profile 43 of the outside curve element 36. Inside and outside curve elements each preferably have a 90° curve in the conveying plane. Alternatively or additionally, there can also be inside and outside curve elements with 45° curves or any other angle values, preferably an even-numbered division of 90°.

As can be seen from FIGS. 15 and 16, the base element 21 can be provided in duplicate, such that on its end facing away from the base plate 22 an outside curve element 36 and an inside curve element 35 can be mounted, for forming a two-track curve. In other words, the inside curve elements 35 and outside curve elements 36 can be provided with identical base element 21, identical base plate 22 and identical substructure 44. The base element 21 can however also be provided in two parts as shown in FIG. 6. Alternatively, the separate guide profiles 43 of a two-track path element can also be provided as a single part.

In FIG. 17, a terminal loop element 37 is shown, for which the guide profile is diverted along a curved pathway coming from one side and the terminal loop element 37 on the same side leaves in the opposite direction.

The terminal loop element 37 can also have on one side two base elements 21 with rear sides 23 together, wherein in the terminal loop element 37 the guide profile of one of the base elements 21 merges along a curved pathway into the guide profile of the other base element 21.

As is shown in FIG. 17, the base element 21 can be provided in multiple parts and can support a separate guide profile 43, along the pathway of which the workpiece carrier 1 is diverted from one path of a two-track path section approaching the other path of the two-track path section.

FIG. 18 shows three rotary elements 38. A rotary element 38 has one to four connection points for further path elements 2, wherein as shown there are preferably four connection points, which form an intersection. Between the connection points, there is a rotating disc 47, on which at least one path element 2 according to the invention is fastened. The rotating disc 47 is preferably formed by a circular base plate 22, which is rotatably mounted in the base plate 22 of the connection points. The connection points and the path elements 2 fastened to the rotating disc 47 are rounded in their joint area according to the circumference of the rotating disc 47. As is shown with the left rotary element 38, two straight elements 34 can be fastened to the rotating disc 47, to form a two-track path section. Alternatively, an inside curve element 35 and an outside curve element 36 can also be mounted, to form a two-track path section with a 90° curve, as is shown with the right rotary element 38. The right rotary element 38 can preferably be used to divide workpiece carriers 1, which are coming from the left path section, onto the two path sections following at an angle of 90°, without the rotating disc 47 having to be rotated during the passing of the workpiece carrier 1. As is shown with the centre rotary element 38, a straight element 34 and up to two inside curve elements 35 can be fastened to the rotating disc 47, wherein this variation cannot be passed with workpiece carriers 1 connected in parallel. A further possibility is to position up to four inside curve elements 35 on the rotating disc 47. Rotary elements 38 can be positioned before the passing by the workpiece carriers 1, such that these, coming from a connection point, following the path of the path element 2 of the rotating disc 47, leave the rotary element 38 at another connection point. In addition, it is possible to rotate the rotating disc 47 only if at least one workpiece carrier 1 is already located at a path element 2 of the rotating disc 47. The workpiece carrier 1 can be thereby pivoted from any first connection point to any second connection point. If a single-track workpiece carrier 1 is used, this can continue on to any path of any connection point. For example, if a workpiece carrier 1 arrives at the upper track of the left connection point on the rotary disc 47 in the case of the left rotary element 38, this can be rotated by 180°, such that the workpiece carrier 1 can leave the rotating disc 47 on the lower path of the left or right connection point.

FIG. 19 shows three transport elements, which can displace workpiece carriers 1 in the conveying plane. With the longitudinal transport element 39, a path element 2 is fastened with its base plate 22 on a displacement device 48, which moves the path element 2 in the transport direction. With the transverse transport element 40, a path element 2 is fastened with its base plate 22 on a displacement device 48, which moves the path element 2 transverse to the transport direction. As shown with the third transport element, the movement axis of the displacement device 48 can also be arranged at an incline to the transport direction and also for example at an incline to the conveying plane. As shown, the displacement device 48 can furthermore have a rotatory axis, for example in the form of a rotating disc 47. Thus, even path sections, which are neither horizontal nor vertical, nor coordinated in terms of alignment, can be connected, which can be the case if existing transport paths are to be retrospectively connected. As shown, the displacement can occur along an axis, alternatively a transport element and combination of a longitudinal transport element 39 and a transverse transport element 40 could exist, such that the transport element is adjustable in a plane along two spatial axes. All the types of path elements 2 stated herein, i.e. for example including lifting elements 41, rotary elements 38 and pivot elements 42, can be provided with a transport element 39, 40.

Path elements 2 can also be mounted on freely moveable (preferably driverless) transport cars, in order to be able to transport workpiece carriers 1 preferably collectively between distributed plants with transport systems according to the invention, wherein the energy supply of the transfer modules 6 can occur by means of the vehicle battery, or by docking a path element 2 of the vehicle in the transport system according to the invention of the path.

FIG. 20 shows a lifting element 41, which can displace workpiece carriers 1 from one path level to another. With the lifting element 41, a path element 2 is fastened with its base plate 22 on a lifting device, i.e. a displacement device 48, which moves the path element 2 perpendicular to the conveying plane. All the types of path elements 2 stated herein, i.e. for example including transport elements 39, 40, rotary elements 38 and pivot elements 42, can be provided with a lifting device.

FIG. 21 shows two pivot elements 42. Pivot elements 42 are also used to change the conveying plane, preferably by 90° or by 180°. The pivot element 42 also has a rotatable axis, about which a path element 2, preferably a straight element 34, is pivoted. In the example of FIG. 21, the conveying plane primarily runs vertically upwards. A workpiece carrier 1, which reaches the pivot element 42 from the first straight element 34, is pivoted by 90° with the first pivot element 42, the rotary axis 49 of which runs parallel to the conveying plane and perpendicular to the transport direction, so that the pivot element 42 abuts the following horizontal transport section and the workpiece carrier 1 can continue to travel along the same. After passing the following two straight elements 34, the workpiece carrier 1 reaches a further pivot element 42, the rotary axis 49 of which runs parallel to the current conveying plane and parallel to the current transport direction. By means of the pivot element 42, the conveying plane is thereby pivoted about the transport direction by 90 degrees, such that the transport direction is maintained, but the workpiece carrier 1 and the path elements 2 are rotated by 90°. The rotary axis 49 is preferably located below the base plate 22. Workpiece carriers 1, which are located on pivot elements 42, do not need to stop, but can continue to move during the pivoting movement, such that the necessary transport time is minimal.

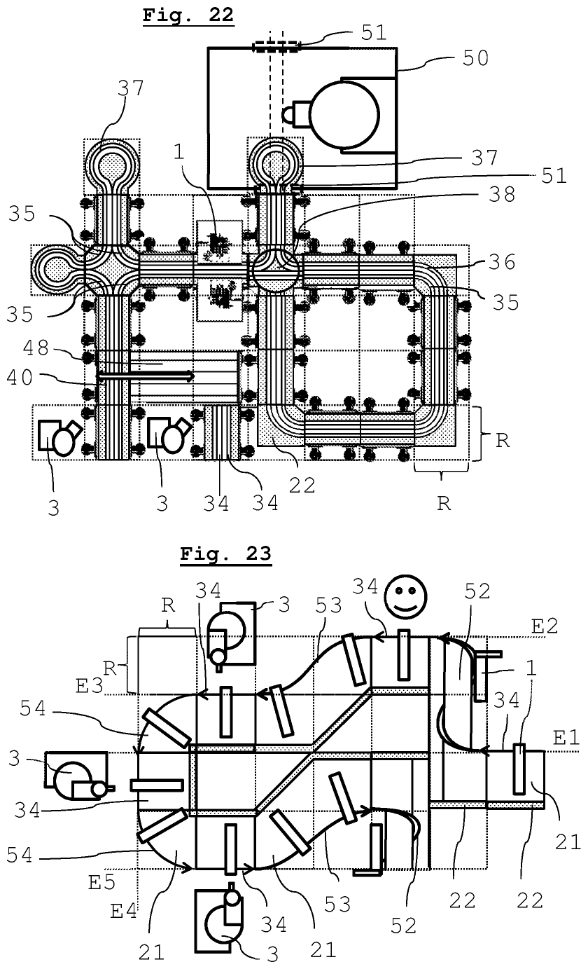

In FIG. 22, an advantageous use of a transport device according to the invention is shown, for connection of a laser welding cell 50 to a transport path. The use of the terminal loop element 37 in the housing of the laser welding cell 50 is advantageous, as the workpiece carrier 1 can be thereby moved into and out of the laser welding cell 50 on the same side, through a lock 51, or an opening. The usual straight path through the laser welding cell 50 is shown with a dotted line, which has the disadvantage that an additional lock 51 is required and that the path must be driven on to the other side of the laser welding cell 50, such that the path must drive directly through all necessary laser welding cells 50, which results in an enormous footprint and little flexibility in the arrangement of the laser welding cells 50 and the path. It would also be possible to enter the laser welding cells 50 with workpiece carriers 1 on a single path and to exit again in the same way, wherein in contrast the terminal loop element 37 has the advantage that the next workpiece carrier 1 can already be moved into the laser welding cell 50 while the preceding one is still exiting the same.

All path elements 2 in the conveying plane (=plane in which the transport direction is situated) preferably have dimensions according to a predefined grid spacing R, such that the path elements 2 can inevitably produce a closed loop when arranged next to one another according to the grid (R×R). The grid spacing R is preferably 360 mm. In FIG. 24, the horizontal grid with the grid spacing R is highlighted with dotted lines.

All straight path elements 2 as well as straight elements 34, lifting elements 41 or transport elements 39, 40 preferably have a length of R or 360 mm, or an integer multiple thereof. Inside curve elements 35 and outside curve elements 36 are preferably located in a square grid section with an edge length of R or 360 mm. The inside curve element 35 preferably has a square footprint with an edge length R/2 preferably as 180 mm, so that in a raster element or on a square base plate 22 with 360 mm edge length, up to four inside curve elements 35 can be provided, or up to two inside curve elements 35 and one straight element 34. Rotary elements 38 preferably have a square base with an edge length of 360 mm. The terminal loop element 37 preferably has a cross-section, which is located within a square base having an edge length of 360 mm. The transverse transport element 40 contained on the path of FIG. 22 is used to move workpiece carriers 1 transverse to the transport direction between two or more grid sections. The transverse transport element 40 has in the transport direction a length of R and has transverse to the transport direction a displacement device 48 having a length of an integer multiple of R. As the straight path element 2 of the transverse transport element 40 can be stopped at any position of the displacement device 48, it can also be used to combine two paths or path elements 2, which are not arranged next to each other according to the grid. The transverse transport element 40 is preferably formed by at least one base plate 22, which is displaceable on the displacement device 48 by means of a drive. In turn, straight elements 34 and/or curve elements 35, 36 can be attached to the base plate 22. In addition, more than one base plate 22 can be displaceable on a displacement device 48.

The transverse transport element 40 is preferably used to split up workpiece carriers 1, which come from at least one path section to at least two path sections, and vice versa. In particular, this can be preferably used to run long-lasting machining steps through two identical workstations 3 in parallel, in order to shorten the production time, or to improve the capacity of the workstations 3 with short machining steps. In place of a transverse transport element 40, the splitting can also occur by means of a rotary element 38, for example with the right rotary element 38 of FIG. 18.

As is shown in FIG. 23, transportation of the workpiece carriers 1 in the transport system according to the invention cannot only take place in a conveying plane. By means of special path elements, the conveying plane can be pivoted or displaced in parallel, i.e. moved to another level. Preferably, a grid spacing R, likewise preferably of 360 mm, is used perpendicularly to the conveying plane. The for example single-track path shown in FIG. 23 begins on the right on a first low, horizontal plane E1 and moves with a helical element 52 into an elevated manual work section on plane E2, which permits ergonomic working. The helical element 52, which has an initial and end slope of 0, is preferably positioned with a height of R or an integer multiple of R. The pitch of a helical element 52 can in particular be 1 R, 2 R or 4 R, such that the helix completes a quarter, half or full rotation within a raster element. The helical element 52 can be formed from one element or from a plurality of sub-elements, for example an initial element with an initial slope of zero and an end element with an end slope of zero and any number of intermediate elements with a constant slope. A helical element 52 with a base area of a grid section will generally be designed as shown as a single-track outer helix, as there is insufficient space within the helix to transport the workpiece carrier 1 and workpiece. With a two-track helical element 52, the inner helix can be used for return transport of empty workpiece carriers 1. A helical element 52 can also naturally have a base area of two×two grid units or more, such that the inner helix provides sufficient space for transporting workpiece carriers 1 including the workpiece.

By means of a riser element 53, which for example has a length of twice the grid spacing, the workpiece carriers 1 are moved along an S-curve having an initial and end slope of zero from the elevated manual work level E2 to another lower system level E3. Depending on which curve radii and path slopes a workpiece carrier 1 can manage, the length of the riser element 53 in the transport direction can be R or a multiple of R.

Instead of providing the riser element 53, when viewed in the transport direction, as a straight element, this could also have a curve profile.

After the riser element 53, a straight element 34 follows, to which a vertical curve element 54 connects, through which the conveying plane is changed by 90 degrees into a vertical plane E4, such that the transport direction is then vertically downwards. Through a further vertical curve element 54 after an intermediate straight element 34, the conveying plane is changed by 90° a further time, whereby a horizontal conveying plane E5 is again achieved, but with upside down workpiece carriers 1. There follows a straight element 34, a riser element 53 and a helical element 52, which are identical to the previously described elements, with the difference that the upside down helical element 52 completes a ¾ rotation within the grid spacing R. Irrespective of the spatial alignment of the conveying plane, the same path elements 2 can be used, such that with a minimal number of different elements a maximum level of flexibility is provided for the path design. Workstations 3 can theoretically be attached along the entire path, i.e. also in the area of the slopes, vertical curves and helixes, as absolute value tracks 4 are also attached for their elements.

With these elements, a position determination can also be omitted, such that during start-up by the successive activation of the transfer modules 6, it is only detectable that workpiece carriers 1 are located in the area of the just activated transfer modules 6, but not at which exact absolute position. In addition, it is advantageous if the individually switchable transfer modules 6 or individually switchable groups of transfer modules 6 have a length, which is short enough that these can always only transfer to one workpiece carrier 1, as thus the order of the workpiece carriers 1 on the path can at least be defined. This is for example the case with the transfer modules 6 of FIG. 4, if these are switchable, actuatable or identifiable by the control system 5 individually or in diagonal pairs. Alternatively, it can also be provided that the workpiece carriers 1 are controlled during operation such that there is always only one said workpiece carrier on an individually switchable or identifiable transfer module 6 or on an individually switchable or identifiable transfer module group, when a path element 2 has no absolute value track 4.

Alternatively or additionally to the absolute value tracks 4 on the base element 21, absolute value tracks 4 can be attached to the surface of the base leg 26 facing towards the base plate 22 for some or all path elements 2, which makes the structure and attachment of the absolute value tracks 4 easier for vertical curve elements 54 and riser elements 53 (only straight band required), but makes this more difficult for inside curve 35 and outside curve elements 36. Workpiece carriers 1 have alternatively or additionally at least one absolute value sensor 20 on the side of their drive element 12 facing towards the base leg 26 for reading this absolute value track 4.

As shown in FIG. 24, the connection of workpiece carriers 1 can also be used to form a scissor lift table 55, such that the standard distance of the mounting plate 19 and thus the workpiece in relation to the path can be configured by the distance between the workpiece carriers 1 of the scissor lift table 55. The serial workpiece carriers 1 are thus only connected via the leg of the scissor lift table 55. The scissor lift table 55 preferably comprises four workpiece carriers 1, wherein each pair of parallel-connected workpiece carriers 1 is connected in series. Each workpiece carrier 1 of the scissor lift table 55 has at the connecting element 18 a hinge joint, the rotary axis of which is parallel to the conveying plane and perpendicular to the transport direction.

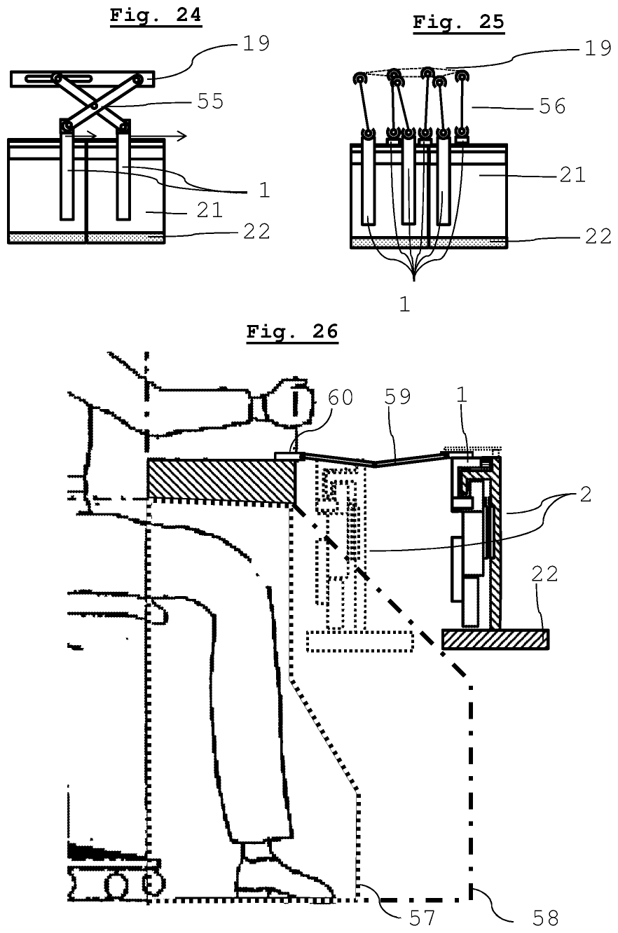

As shown in FIG. 25, the connection of workpiece carriers 1 can also be used to form a 6D movement platform 56, such that any alignment of the mounting plate 19 and thus the workpiece in relation to the path can be configured by the distance between the workpiece carriers 1 of the movement platform 56. Each workpiece carrier 1 of the movement platform 56 is connected with the mounting plate 19 via a rod. The rods are each preferably connected by means of a ball joint with one of the workpiece carriers 1 and the mounting plate 19. Each workpiece carrier 1 is moveable independently of the others, such that the position and alignment of the mounting plate 19 is also adjustable during transportation along the path. A movement platform 56 may preferably comprise 3 to 6 workpiece carriers 1, for the realisation of a 3D to 6D movement platform 56. As shown, workpiece carriers 1 of the movement platform 56 are thus located on different tracks of a multi-track, preferably two-track path section.

Broadly speaking, at least a workpiece carrier 1 on the connecting element 18 can have a joint with at least one rotatory degree of freedom in or parallel to the conveying plane. Preferably, at least two workpiece carriers 1 are each equipped with such a joint, wherein to each joint a rod (or a bar or a leg) connects, which is connected via a further joint with the mounting plate 19, wherein the further joint has at least a degree of freedom in the or parallel to the plane of the mounting plate 19.

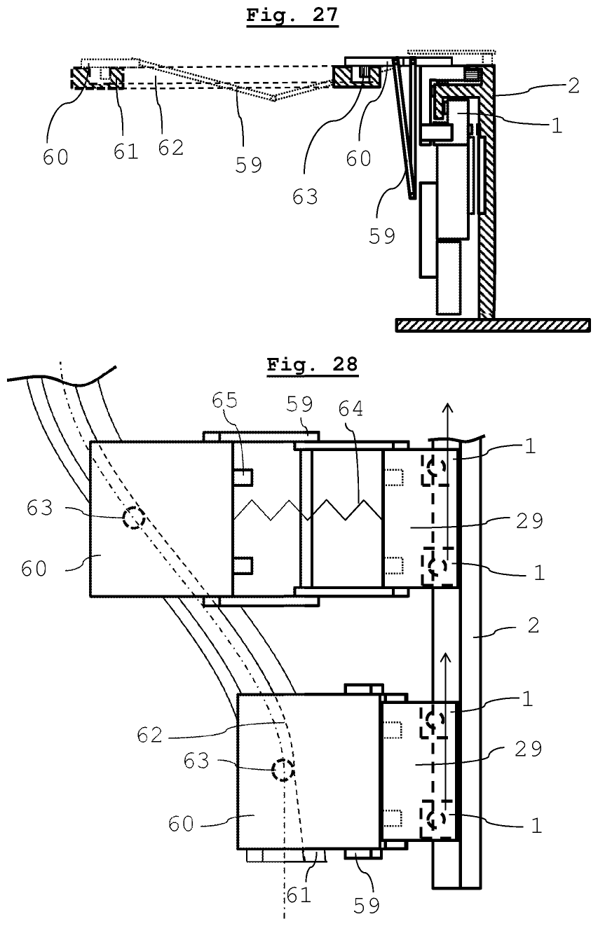

FIG. 26 highlights a manual workplace. With manual workplaces, there is a differentiation between those with small leg clearance 57 and those with large leg clearance 58. While the transport system according to the invention can be used without further modification for manual workplaces with small leg clearance 57 (shown with dotted line), the shown embodiment variation according to the invention can be used for those with large leg clearance 58. With this, a coupling rod 59 is provided on the workpiece carrier 1, with one end of said coupling rod being mounted on the mounting plate 19 or on the connecting element 18 of the workpiece carrier 1 and the other end receiving a support plate 60 or another receiving element for the workpiece. With the coupling rod 59, the support plate 60 can either be moved towards the workpiece carrier 1 or away from the same, as shown in FIG. 27 and FIG. 28.

Preferably, the coupling rod 59 is designed passively, i.e. without actuators such as a cylinder or spindle drive for active adjustment of the coupling rod 59. Preferably, the driving of the coupling rod 59 is effected in that the support plate 60 has at least in the area of a manual workplace a separate guide system 61, which abuts the support plate 60 and moves along a guideway 62 predefined by the guide system 61 away from the mounting plate 19 or from the connecting part 29 of at least one workpiece carrier 1. The coupling rod 59 is used to transfer the forward movement of the workpiece carrier 1 or of the workpiece carrier connection along the path element 2 to the support plate 60, such that the support plate 60 of the guideway 62 of the guide system 61 follows. For this purpose, the support plate 60 can have at least one roller 63, which rolls onto a guide surface of the guide system 61 forming the guideway 62. As is highlighted in FIG. 28, the workpiece carrier 1 can be connected via a return element 64, for example a spring, with the connecting part 29, such that the roller 63 is held against the guide surface. When the guideway 62 approaches the guide of the path element 2 again, the support plate 60 is drawn back to the connecting part 29. As is shown in FIG. 28, the support plate 60 can have docking bolts 65 or other connecting elements, which protrude into recesses of the connecting part 29, or vice versa. The support plate 60 is thereby fixed in its position on the connecting part 29 and releases the coupling rod 59, such that in areas into which the coupling rod 59 is brought completely together, i.e. for example in the area of automated workstations 3, no separate guide system 61 is necessary for the support plate 60. In the event that the coupling rod 59 is brought completely together, the support plate 60 is preferably fixed on the workpiece carrier 1 or on the workpiece carrier interconnection, for example by the return element 64 or by a mechanical or electromechanical lock, which is only released with the existence of a separate guide system 61 of the support plate 60.

If the workpiece carriers 1 in FIG. 28 moves from bottom to top, the support plate 60 is initially fixed against the workpiece carriers 1 on the lower edge of the image, for example by docking bolts 65 and the return element 64. When the workpiece carriers 1 are moved again, the rollers 63 of the support plate 60 enter the guide of the guide system 61 and come into contact with a guide surface, roll onto the same and thus follow the guideway 62. The pathway of the roller 63 is shown with dots and dashes, and is aligned parallel to the guideway of the path elements 2 in the area without guide system 61 and then parallel to the guideway 62.

As shown, the support plate 60 can be moved away in the conveying plane. Alternatively or additionally, the moving away could also occur vertically to the conveying plane with a component, for example by lifting the support plate 60 to a higher level above the connecting part 29 by means of the guideway 62 of a guide system 61.

1-20. (canceled)

21. A transport system for workpiece carriers along a path, comprising:
a guide for the workpiece carriers; and
at least one transfer module adapted to run along said path, the at least one transfer module adapted to provide at least one of consistent transfer of energy to the workpiece carriers and consistent communication with the workpiece carriers,
wherein each of a plurality of workpiece carriers has itself a drive and energy storage,
wherein the drive takes place via a drive means rolling on the guide of the path, said drive means being driven by a motor of the workpiece carrier, and each workpiece carrier has at least one receiving module for receiving at least one of transferred energy and communicating with the transfer modules,
wherein at least one absolute value track extends along the path, and
wherein the absolute value track is provided in the area of at least one of the transfer modules with unique code values for position coding along the path and each of the plurality of workpiece carriers has at least one absolute value sensor, the at least one absolute value sensor adapted to read out the absolute value of the absolute value track.

22. The transport system according to claim 21, wherein:
along the path a plurality of transfer modules, and a plurality of absolute value tracks, are arranged successively, a plurality of absolute value tracks in this context means that absolute values repeat along the path,
wherein an area along the path with unique code values for position coding along the path is regarded as an absolute value track,
one or a plurality of transfer modules run along a length of each absolute value track, and
transfer modules of each absolute value track are actuatable independently of the transfer modules of the other absolute value tracks.

23. The transport system according to claim 22, wherein the energy transfer to the workpiece carriers for each transfer module, or for each group of transfer modules that is allocated to an absolute value track, is individually controllable or switchable.

24. The transport system according to claim 22, wherein:
a data connection with the workpiece carriers exists via the transfer modules, and
the transfer modules are in data connection with a control system and through the control system it is detectable from which transfer module which is assigned to an absolute value track, or from which group of transfer modules which is assigned to an absolute value track, received data originates.

25. The transport system according to claim 21, wherein:
the path comprises a plurality of path elements, which each path element comprises a guide profile for the workpiece carriers, and
each path element comprises at least one absolute value track and at least one transfer module along a length of its guide profile.

26. The transport system according to claim 25, wherein:
each path element comprises a base element, and
the workpiece carriers, as viewed on one side in a direction of transport, are positioned beside the base element, such that two path elements are positionable next to each other with the rear sides of their guide profiles facing each other.

27. The transport system according to claim 26, wherein:
the guide profile of each path element, as viewed on one side in the direction of transport, are located at the side of the base element,
the guide profile comprises a base leg, which extends away from the base element on one side,
at the end of the base leg remote from the base element a further leg extends away at an angle, and
an additional leg extends away from the base element spaced at a distance from the base leg on the same side as the base leg.

28. The transport system according to claim 27, wherein the drive means, that rolls on the path, of the workpiece carriers abuts the surface of said further leg that faces the base element.

29. The transport system according to claim 27, wherein at least one guide roller, preferably a pair of guide rollers, of the workpiece carrier abuts the surface of said further leg that faces away from the base element.

30. The transport system according to claim 27, wherein a guide roller or a pair of guide rollers of the workpiece carrier abuts the surface of the base leg that faces said additional leg and a guide roller or a pair of guide rollers of the workpiece carrier abuts the surface of said additional leg which faces the base leg.

31. The transport system according to claim 27, wherein:
the base element extends from the base leg to a base plate, and
at least one absolute value track and at least one transfer module are attached to the base element in the area between the base leg and base plate and each workpiece carrier has on its side facing the base element at least one absolute value sensor and at least one receiving module.

32. The transport system according to claim 25, wherein:
each workpiece carrier comprises a drive element, which comprises the drive means that rolls on the path, the motor of said drive means, at least one energy storage, the absolute value sensor, at least one receiving module and a control circuit board,
each workpiece carrier comprises a guide element, which comprises guide rollers and a connecting element for assembly of components to be transported, such as mounting plates and connecting parts,
the guide element is connected via a connecting element with the drive element, and
the connection between the guide element and drive element is detachable, in order to be able to insert the workpiece carrier into the guide profile of the path elements from a direction transverse to a transport direction of the path element or to remove said workpiece carrier from the same.

33. The transport system according to claim 25, wherein:
each path element has two rows of transfer modules running parallel in a transport direction of the path element,
each row has at least one transfer module and the transfer modules of the two rows, when viewed in the transport direction, are arranged offset to one another, and
each workpiece carrier has two receiving modules with one receiving module being aligned to each of the rows.

34. The transport system according to claim 33, wherein a transfer module of one row protrudes past a joint area of one path element with the subsequent path element.

35. The transport system according to claim 21, wherein at least two workpiece carriers are mechanically interconnected.

36. The transport system according to claim 35, wherein:
at least one of the workpiece carriers has a step motor and at least one of the workpiece carriers has a servomotor, and
the drive of workpiece carriers with servomotors is inactivated in manual work areas.

37. The transport system according to claim 21, wherein:
on at least one workpiece carrier a coupling rod is attached, which is connected with a support plate, and
the support plate can be moved away from the workpiece carrier and thus from the path by means of the coupling rod.

38. The transport system according to claim 37, wherein the support plate can be moved away from the path or moved towards the path along a guideway of a separate guide system.

39. The transport system according to claim 25, wherein the path has one or a plurality of path elements selected from the group of:
a straight element, which, when viewed in a transport direction of the path, comprises a straight base element and a straight guide profile;
an inside curve element, which, when viewed in the transport direction of the path, comprises a circular-segmented base element, wherein a circular-segmented guide profile is attached to the side of the base element with a smaller radius.
an outside curve element, which, when viewed in the transport direction, comprises a further circular-segmented base element, wherein the a further circular-segmented guide profile is attached to the side of the base element with a greater radius, wherein the outer radius of the guide profile of the inside curve element is equal to the inner radius of the guide profile of the outside curve element;
a terminal loop element, which has on one side two base elements with rear sides together, wherein in the terminal loop element the guide profile of one of the base elements merges along a curved pathway into the guide profile of the other base element;
a rotary element, which has at least one path element, which is rotatable or pivotable about an axis perpendicular to a conveying plane of the path;
a transport element, which has at least one path element, which is displaceable between at least two positions in the conveying plane;
a lifting element, which has at least one path element, which is displaceable between at least two positions transversely, in particular vertically, to the conveying plane;
a pivot element, which has at least one path element, which is rotatable or pivotable about an axis in the conveying plane or parallel to the conveying plane;
a helical element, which is a path element, whose guide for the workpiece carriers runs in a helical manner;
a riser element, which is a path element, whose guide for the workpiece carriers runs according to an S-curve with an initial and end slope of zero; and
a vertical curve element, whose guide for the workpiece carriers runs along a curve, which rotates the conveying plane by an angle of 90°.

40. A method for localization of workpiece carriers along a path of a transport system, comprising:
providing consistent transfer of energy to the workpiece carriers, from said transfer modules, wherein the path has a guide for the workpiece carriers, and a plurality of transfer modules run along the path;
receiving the transferred energy by at least one receiving module, wherein each of a plurality of workpiece carriers has itself a drive and energy storage, wherein the drive takes place via a drive means rolling on the guide of the path, said drive means being driven by a motor of the workpiece carrier, and each workpiece carrier has at least one receiving module, wherein a plurality of mutually adjoining absolute value tracks extend along the path, wherein a unique code value exists along the path for each position within each of said absolute value tracks, wherein at least two absolute value tracks have at least one identical code value;
assigning one or a plurality of transfer modules to one absolute value track, wherein each of the plurality of workpiece carriers has at least one absolute value sensor, which reads out the momentary code value of a position of the particular one of the plurality of workpiece carriers on one of the absolute value tracks;
supplying energy to transfer modules, which are assigned to an absolute value track, independently of transfer modules of other absolute value tracks; and
sending, with each workpiece carrier as soon as it receives energy from a transfer module, a momentarily measured code value of the absolute value track to a control system; and localizing workpiece carriers with the control system by detecting which workpiece carrier sends a momentarily measured code value upon supplying energy to transfer modules of which absolute value track.

41. A method for localization of workpiece carriers along a path of a transport system, comprising:
providing consistent communication with the workpiece carriers, by said transfer modules, wherein the path has a guide for the workpiece carriers, and a plurality of transfer modules run along the path;
driving drive means by a motor of the workpiece carrier, wherein each of a plurality of workpiece carriers has itself a drive and energy storage, wherein the drive takes place via the drive means rolling on the guide of the path, and each workpiece carrier has at least one receiving module for communication with the transfer modules, wherein a plurality of mutually adjoining absolute value tracks extend along the path, wherein a unique code value exists along the path for each position within each of said absolute value tracks, wherein at least two absolute value tracks have at least one identical code value;
assigning one or a plurality of transfer modules to one absolute value track, wherein each of the plurality of workpiece carriers has at least one absolute value sensor, which reads out the momentary code value of a position the particular one of the plurality of workpiece carriers on one of the absolute value tracks;
sending with each workpiece carrier a momentarily measured code value of the absolute value track via at least one of said transfer modules to a control system; and
localizing workpiece carriers with the control system by determining via which transfer module or via which group of transfer modules, which are assigned to one of said absolute value tracks, a momentarily measured code from a workpiece carrier was received.
